(19) United States
(12) Patent Application Publication
(10) Pub. No.: US 2015/0228130 A1
(43) Pub. Date: Aug. 13, 2015

(54) Data recording device for a vehicle network

(71) Applicant: CONTINENTAL AUTOMOTIVE GMBH, Hannover (DE)

(72) Inventors: Helge Zinner, Magdeburg (DE); Josef Nöbauer, Neukirchen-Balbini (DE)

(21) Appl. No.: 14/426,912

(22) PCT Filed: Sep. 6, 2013
(86) PCT No.: PCT/EP2013/068500

§ 371 Date: Mar. 9, 2015

(30) Foreign Application Priority Data
Sep. 10, 2012 (DE) 10 2012 216 012.4

(51) Int. Cl. G07C 5/08; B60R 16/023

(52) U.S. Cl. CPC G07C 5/08; B60R 16/023

(57) ABSTRACT

A data recording device for recording communication data in a vehicle network includes a first input for receiving first communication data from a first point in the vehicle network and a second input for receiving second communication data from a second point in the vehicle network. The data recording device provides the first communication data with a first time stamp and the second communication data with a second time stamp. The first time stamp and the second time stamp are synchronized with one another.

### CROSS-REFERENCE TO RELATED APPLICATIONS

This is a U.S. national stage of application No. PCT/EP2013/068500, filed on 6 Sep. 2013, which claims priority to the German Application No. DE 10 2012 216 012.4 filed Sep. 10, 2012, the content of both incorporated herein by reference.

### BACKGROUND OF THE INVENTION

1. Field of the Invention

The invention relates to a data recording device for recording communication data in a vehicle network, to a diagnostic arrangement, and to a method for recording communication data in a vehicle network.

2. Related Art

Data recording devices or data loggers are used to read communication data between electronic components, for example control devices, of a vehicle and to process this data further for diagnostic purposes.

For example, CAN, FlexRay and MOST buses can network the electronic components of a vehicle network or of a vehicle communication network to one another and can thus form a networked vehicle network. A star-shaped network topology in which a central gateway connects all buses and simultaneously provides external vehicle access to data recording devices, for example via an individual diagnostic connector, has become established for the purpose of connecting the field buses. As a result, all signals in the bus system connected to the central gateway can be concomitantly read at the runtime.

In accordance with the medical term “diagnosis”, vehicle diagnosis describes the precise assignment of findings to faults in electrical and electronic components in vehicles. A number of technical methods and applications, which are used, for example, during fault analysis in the event of repair, in quality assurance for statistical evaluations and in vehicle development are combined under the term “vehicle diagnosis”. In addition, vehicle diagnosis is used to inform or warn the driver of faults, which have occurred and to initiate the deactivation of vehicle properties if their operation cannot be unequivocally guaranteed.

Vehicle diagnosis can be fundamentally divided into diagnostic parts inside the vehicle—on-board diagnosis and also vehicle self-diagnosis—and diagnostic parts outside the vehicle—off-board diagnosis (diagnostic information, diagnostic tools).

In the stricter sense, vehicle diagnosis in the automobile industry may mean (diagnostic) communication between an external testing device, the diagnostic tester (vehicle diagnostic system) and the individual electronic components using a diagnostic protocol.

In this case, the diagnostic tester or testing device may comprise a data recording device, which acquires and reads the communication data between the electronic components.

Diagnostic data (standardized in the meantime using ODX), which describe the communication and are held in the diagnostic systems of the off-board diagnosis, can be used as the link between the diagnostic tester and the vehicle. The data describe the diagnostic protocol used, the individual commands, their possible responses from the electronic component and the interpretation of the data, for example conversion into physical values.

Diagnostic access (for example wireless or wired), which can also be used to flash the electronic components, can be used as access to the vehicle diagnosis.

Diagnostic testers, which are restricted to recording the on-board communication, are generally used in quality assurance and during vehicle development. This may produce relatively large volumes of data, which are difficult to analyze. Some examples based on the automotive sector are MultiLOG (GiN, Vector Informatik), MC Log (IHR GmbH), CCO DLII (Condalo GmbH), M-LOG (IPETRONIK GmbH & Co KG), blue PiraT (Telemotive).

Another group of diagnostic testers is predominantly purely software-based (can therefore be operated on laptops or industrial PCs in the automobile) and also provides a data logger functionality, for example CANoe, X-Analyzer, canAnalyzer, CANcorder, EDICmobil, TraceRunner, IPEmotion, among others. Some of these vehicle diagnostic tools provide additional functionalities, for example (rest bus) simulation (CANoe).

There are also diagnostic testers that support the two main functionalities of fault memory analysis and recording of the data bus communication. Examples are CANape (Vector Informatik), DiagRA MCD (RA Consulting) and Tedradis (IT-Designers). These create a temporal relationship between the recorded CAN messages and the read fault memories of the electronic components and facilitate analysis in this manner. The Tedradis tool additionally assists the user by further data reduction options (for example Trigger), visual preprocessing of the relevant data, reading and recording of vehicle information, for example control device coding, among others. Manufacturers of embedded devices such as Telemotive (blue PiraT) and Condalo GmbH (CCO DLII) are also currently working on functions which assist the user when analyzing the data.

However, in all of these systems, the data logger is connected to a central interface of the vehicle network if the data in an entire vehicle are read. Individual control devices can also be separately read during development. In addition, this may also depend on the field bus itself and the possible network topologies. In the case of MOST (with a ring structure), the position may also play a decisive role, for example.

Ethernet can also be used as a communication medium between electronic components in the vehicle.

In the case of relatively large volumes of data for example, vehicle access via Ethernet may prove to be very advantageous as new diagnostic access. Introduction of diagnostic access can be advanced even more quickly with the introduction of standardized IP diagnostic interfaces, as specified in ISO 13400, using Ethernet as the physical layer.

In contrast to the existing bus systems such as MOST, FlexRay and CAN, Ethernet is nowadays not a shared medium, however. In the case of a shared medium, all subscribers (electronic components) share the bandwidth and all have access to the data contents. In the original version, Ethernet was also a shared medium, but is substantially operated only as a switched medium, in the case of which the maximum bandwidth (for example 100 Mbit/s) is respectively available on each link (a network connection between two electronic components) in both directions (full duplex).

This may result in problems when reading communication data since communication data which have been read must be transmitted to the central gateway via a network connection, which is simultaneously supposed to be used to transmit communication data between two electronic components. Further problems may also arise: communication is not distributed in the entire network. Communication is usually carried out only between adjacent nodes. If the links are busy, the entire communication cannot be distributed using an equally fast link. This may result in a bottleneck in the bandwidth.

This is also explained in more detail further below with reference to FIG. 1.

### SUMMARY OF THE INVENTION

An object of the invention is to provide an efficient diagnostic system for a vehicle network, in which no data are lost and in which a temporal assignment or the temporal sequence of the data can remain.

One aspect of the invention relates to a data recording device or a data logger for recording communication data in a vehicle network. The vehicle system may comprise a plurality of network connections that connect electronic components of a vehicle, for example of an automobile, a truck, a bus, a motorcycle, etc.

According to one embodiment of the invention, the data recording device comprises a first input for receiving first communication data from a first point in the vehicle network and a second input for receiving second communication data from a second point in the vehicle network. In other words, the data recording device can be connected to different network connections or network cables of the vehicle network via at least two inputs. The data recording device may be designed to log communication data at different points in the vehicle network. This makes it possible to avoid having to use network connections to transmit communication data between electronic components and the data recording device.

For example, the data recording device may gather communication data from the vehicle network in a parallel manner using a plurality of inputs or interfaces and may optionally process the data further. It should be understood that the inputs may be directly connected to the relevant points in the network, that is to say the communication data are transmitted from the points to the inputs using separate lines or connections which are not part of the vehicle network. Such a connection may comprise a TAP (T-piece) or an additional switch. An existing connection between the electronic components can be disconnected for this purpose.

The data recording device is also designed to provide the first communication data with a first time stamp and to provide the second communication data with a second time stamp, the first time stamp and the second time stamp being synchronized with one another. This makes it possible to temporally relate and/or temporally log communication data which have been read in from different points and/or else from different devices in the vehicle network in order to be able to distinguish between an action event and a reaction event in the data, for example.

If the communication data already have time stamps before they have been read in, it is also possible for these already existing time stamps to be temporally related and/or temporally compared. FlexRay and Ethernet AVB, for example, provide time-synchronous data communication.

The data recording device may be designed to use a time synchronization protocol to synchronize the communication data. In this case, communication data may be recorded in a distributed manner in the entire vehicle network and a time stamp may be assigned to the communication data.

According to one embodiment of the invention, the vehicle network comprises Ethernet connections. The first communication data and the second communication data may be Ethernet data packets. The data recording device may be designed to read in or log Ethernet communication data. The communication data may be recorded from an Ethernet-based network and processed.

For example, the data recording device may have a plurality of Ethernet ports as inputs in order to record data at different locations in the vehicle network.

According to one embodiment of the invention, the data recording device comprises an output for outputting the first communication data and the second communication data. The data recording device may be designed to temporally organize the first communication data and the second communication data using the first and second time stamps. This makes it possible to temporally relate and further process the communication data.

According to one embodiment of the invention, the data recording device comprises a synchronization input for synchronizing the data recording device with a further data recording device, with the result that the first and second time stamps are synchronized with time stamps of the further data recording device. If a plurality of data loggers are used, they can be in turn be synchronized with one another. This makes it possible to construct a distributed logging system that comprises a plurality of data recording devices.

For the purpose of synchronizing the data recording devices, it is possible to use a protocol, for example IEEE1588 or IEEE802.1AS, to temporally synchronize a plurality of the data recording devices. This also makes it possible to record the communication data in very large Ethernet networks (that is to say a large number of individual connections) with the aid of a plurality of synchronized data recording devices and to establish a temporal relationship of the recorded data.

According to one embodiment of the invention, the data recording device and its logic are at least partially implemented using hardware. For example, the time stamps may already be provided by a corresponding hardware unit when receiving communication data. This possibility is also used, for example, in IEEE1588 and IEEE802.1AS and is already supported by various modules. These time stamps make it possible to relate the communication of each individual connection to the other connections.

The use of a corresponding hardware unit makes it possible to achieve an accuracy for the time stamps in the range of nanoseconds (less than 10 nanoseconds).

Another aspect of the invention relates to a diagnostic arrangement, which can be used to test a vehicle network in a vehicle.

According to one embodiment of the invention, the diagnostic arrangement comprises a vehicle network that comprises a plurality of electronic components and a plurality of network connections that connect the electronic components. The diagnostic arrangement also comprises a data recording device as described above and below.

According to one embodiment of the invention, an input of the data recording device is connected to an output of a network switch. A plurality of inputs of the data recording device may be connected to a plurality of switches (for example via a network cable and a connector) in order to read in data at different locations in the vehicle network. The first or second point from which the communication data originate may therefore be a switch.

According to one embodiment of the invention, an input of the data recording device is connected to a network line by a tap. The inputs may also be connected to a plurality of taps on different network lines which provide a network connection. The first or second point from which the communication data originate may therefore be a network connection or a network line.

Another aspect of the invention relates to a method for recording communication data in a vehicle network. It should be understood that features of the method, as described above and below, may also be features of the data recording device and/or of the diagnostic arrangement and vice versa.

According to one embodiment of the invention, the method comprises:
receiving first communication data from a first point in the vehicle network in a data recording device;
receiving second communication data from a second point in the vehicle network in the data recording device;
providing the first communication data with a first time stamp in the data recording device; and
providing the second communication data with a second time stamp in the data recording device, the first time stamp and the second time stamp being synchronized with one another.

Data from a plurality of points in a vehicle network can be recorded or read in and temporally compared using a single data recording device.

According to one embodiment of the invention, the method also comprises:
synchronizing the data recording device with a further data recording device. The comparison can also be carried out between a plurality of data recording devices that may be synchronized with one another.

The method makes it possible to log the communication in an entire network, for example an Ethernet vehicle network, and to establish a temporal relationship. The recording can be carried out independently of the bandwidth of the network by the plurality of inputs and optionally scalability by using a plurality of data loggers. This makes it possible to provide sufficient capacity to record all data.

The inputs or logging ports together with the extended functionality of time synchronization make it possible to assign a time stamp to the arriving data packets. As a result, the data recorded at different locations can be exactly assigned in terms of time. This makes it possible to find faults by recording the communication in a vehicle network, which faults may otherwise be undiscovered or may be discovered only using more complicated methods.

The described method does not influence or distort, in particular, the communication behavior (for example the temporal sequence) of the network which is intended to be examined.

### BRIEF DESCRIPTION OF THE DRAWINGS

Exemplary embodiments of the invention are described in detail below with reference to the accompanying figures, in which:

FIG. 1 schematically shows a vehicle communication network having a diagnostic device;

FIG. 2 schematically shows a vehicle communication network having a diagnostic device;

FIG. 3 schematically shows a diagnostic arrangement according to one embodiment of the invention;

FIG. 4 schematically shows a diagnostic arrangement according to one embodiment of the invention; and

FIG. 5 shows a flowchart for a method for recording communication data according to one embodiment of the invention.

Identical or similar parts are fundamentally provided with the same reference symbols.

### DETAILED DESCRIPTION OF THE PRESENTLY PREFERRED EMBODIMENTS

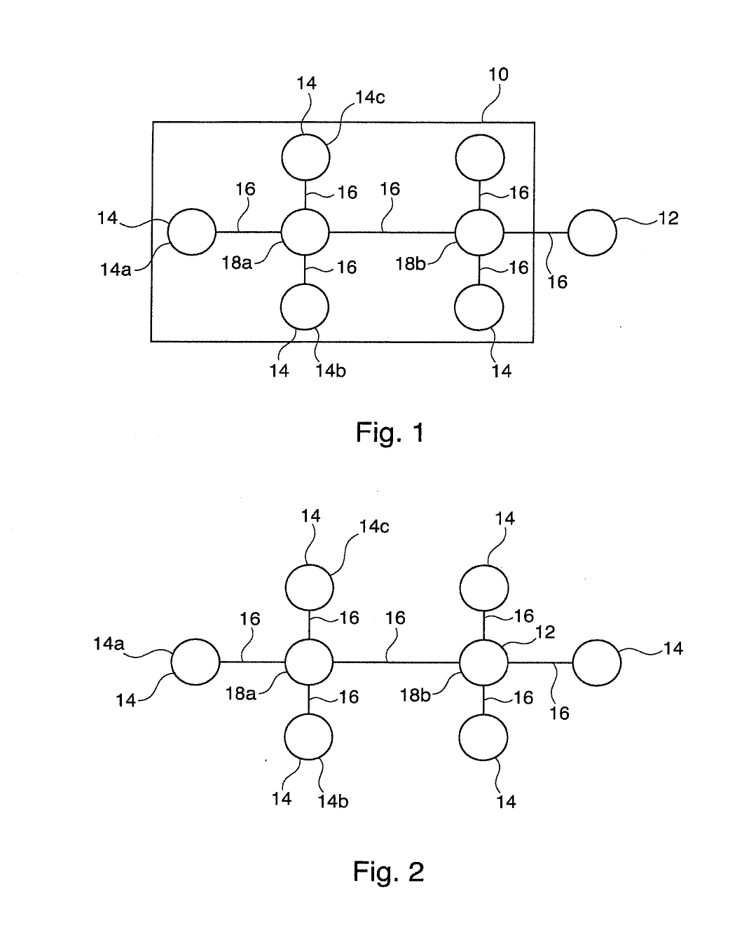

Over the coming years, Ethernet will not only be a diagnostic interface to the automobile but will also be used in the vehicle network in the vehicle. On account of the wide bandwidth of Ethernet networks, new solutions may be required in order to ensure a logging functionality. This is also explained in more detail with reference to the two following FIGS. 1 and 2.

FIG. 1 schematically shows a vehicle communication network 10 having a star-star topology and a diagnostic device 12.

In this case, electronic components 14 are each connected to a switch 18a, 18b by a point-to-point connection 16 with a full-duplex bandwidth of 100 Mbit/s (that is to say 100 Mbit/s in both directions in each case). The connections 16 may be provided using an Ethernet line, for example.

The diagnostic device 12 is connected to switch 18b, by way of example.

A problem may occur as follows:

Device 14a communicates with device 14b with a bandwidth of 90 Mbit/s and device 14c communicates with device 14b with a bandwidth of 70 Mbit/s. This communication is possible without any problems since switched Ethernet has full-duplex capability. This means that the transmitting direction does not influence the receiving direction.

However, if the entire communication is intended to be forwarded to the diagnostic device 12, for example by a method known as “port mirroring”, the connection 16 between switch 18a and switch 18b is a bottleneck.

Port mirroring makes it possible to mirror the network traffic from one or more ports (inputs) of a switch to another port (which is also called mirror port). With active port mirroring, a data rate would theoretically be 90 Mbit/s+70 Mbit/s=160 Mbit/s and would therefore be 60 Mbit/s above the data rate which can actually be transported. Switch 18a will accordingly reject data packets and not all data packets will arrive at the diagnostic device 12.

FIG. 2 schematically shows another vehicle network 10 having a diagnostic device 12 which is integrated in the switch 18b.

In the vehicle communication network 10, both switches 18a, 18b, the electronic component 14a and the switch 18a, and the electronic component 14b and switch 18a are connected by means of a 1000 Mbit/s connection 16.

Otherwise, the vehicle communication network 10 shown in FIG. 2 corresponds to the network shown in FIG. 1.

In this scenario as well, data transport to the diagnostic device 12 cannot always be guaranteed if, for example, the communication from the electronic component 14a to the electronic component 14c also provides the speed of 1000 Mbit/s. Assuming that the electronic component 14a communicates with the electronic component 14c at 950 Mbit/s and assuming that the electronic component 14c communicates with the electronic component 14b at 60 Mbit/s, the connection 16 between the two switches 18a, 18b is overloaded (1010 Mbit/s instead of the maximum of 1000 Mbit/s).

These data rates may occur, for example, in cameras used in vehicles when transmitting videos.

The diagnostic devices shown in FIGS. 1 and 2 have a data logger connected to the network 10 only via a single data interface. The network topologies shown in FIGS. 1 and 2 can therefore generate communication data that cannot be completely recorded by such data loggers. In the worst-case scenario, only one connection 16 can be recorded.

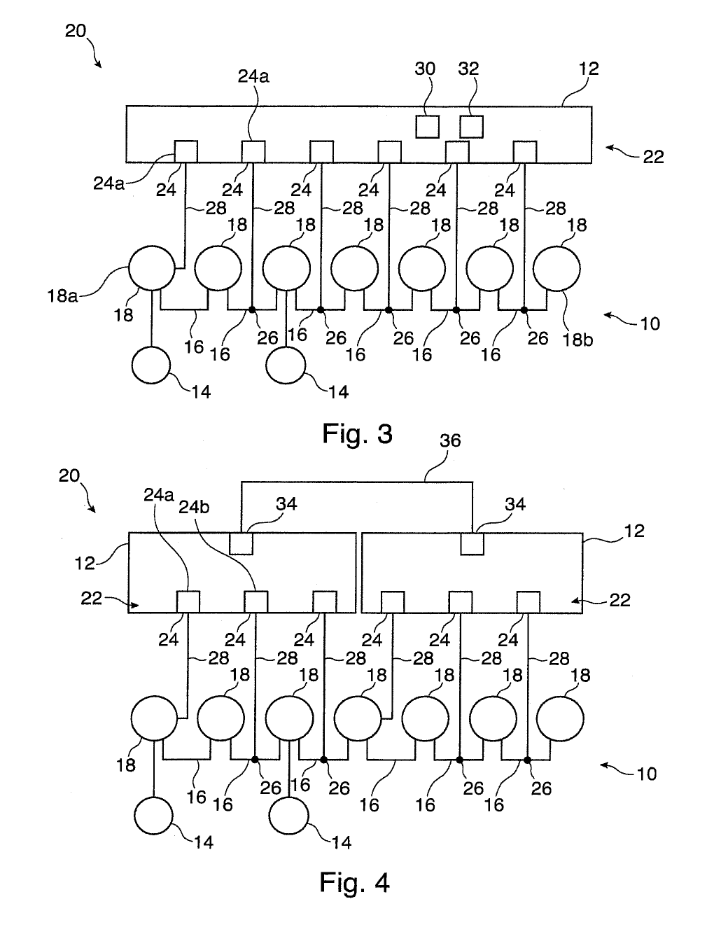

FIG. 3 schematically shows a diagnostic arrangement 20 which comprises a vehicle network 10 and a diagnostic device 12.

The vehicle network 10 has a daisy-chain-based topology in which a plurality of switches 18 are arranged in a row. The switches 18 are connected to one another via network connections 16 via which they can interchange communication data, for example at 100 Mbit/s. Electronic components 14 which are illustrated only by way of example here can be connected to each switch.

With a daisy-chain topology, the amount of cabling can be kept smaller and equipment variants can be implemented more easily in comparison with a star topology. However, it should be understood that the vehicle network 10 shown in FIG. 3 may also have other topologies, for instance the topology shown in FIGS. 1 and 2.

However, a daisy-chain topology may have weaknesses in the case of a single diagnostic interface. In terms of the principle, this topology resembles the topology of conventional bus systems such as MOST, CAN and FlexRay. If, for example, switch 18a communicates with switch 18b, this bandwidth is also no longer available to the other switches 18 in between. Each switch 18 can transmit data without any problems via a connection 16 to its neighboring node at 100 Mbit/s without this resulting in packet losses. A diagnostic device having only one interface to the daisy chain of the vehicle network 10 can generally never receive all data.

However, the diagnostic device 12 has a data recording device 22 or an Ethernet data logger 22 having a plurality of inputs 24 or Ethernet or logging ports 24 which can be used to read in communication data from a plurality of points in the network 10. Each of the inputs 24 is connected to a switch 18a or is connected to a network connection 16 via a tap 26. The connection can be effected, for example, using a separate (spur) line 28.

The data recording device 22 merges the communication data from the inputs 24 in its computing unit. The numerous interfaces 24 solve the bandwidth problem illustrated further above. In the case of standard Ethernet, it may be necessary for both communication partners to have the bus speed. A 1000 Mbit/s port which is connected to a 100 Mbit/s port would therefore be able to communicate only with the greatest common bandwidth, 100 Mbit/s in this case.

The data recording device 22 comprises a further functionality which is also used in the new Ethernet standard IEEE802.1AS. The inputs 24 log the arrival time of the communication data. The inputs 24 are temporally synchronized and use the same time base. They can therefore accurately assign the communication data arriving in a parallel manner at other inputs 24, and the data recording device 22 can then merge the communication data if necessary.

In addition to the data recording device 22, the diagnostic device 12 may have further components, for instance a filter 30 for filtering the time-synchronized communication data, a display 32 for displaying the communication data etc.

FIG. 4 schematically shows a further diagnostic arrangement 20 which comprises a plurality of diagnostic devices 12. The diagnostic devices 12 or their data recording device 22 each comprise for this purpose a further input 34 or Ethernet or logging port 34 with which the data recording device 22 can be synchronized. An additional connection 36 between the distributed diagnostic devices 12 is provided for this purpose in order to synchronize the diagnostic devices. The data logger function of the arrangement 20 is therefore distributed to a plurality of entities. The data can be merged synchronously in terms of time.

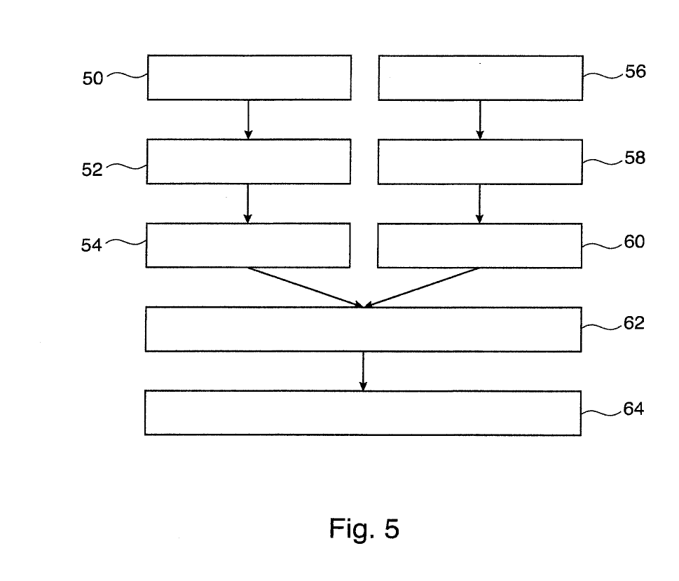

FIG. 5 shows a flowchart for a method for recording communication data. Communication data can be read into the inputs 24 in data packets, for example.

In step 50, a first data packet is received or read in at the input 24a. In step 52, a first time stamp is generated. In step 54, the first time stamp is added to the arriving first data packet.

In step 56, a second data packet is received or read in at the input 24b. In step 58, a second time stamp is generated. In step 60, the second time stamp is added to the arriving second data packet.

The first and second time stamps may be hardware time stamps if the data recording device 22 is implemented using hardware.

In step 62, the two data packets are centrally merged. For example, the data packets may be added to a common data stream.

In step 64, the first time stamp and the second time stamp are compared and an arrival sequence is generated for the two data packets.

The method can be used to merge arriving data packets from a plurality of sources 18, 16 using a computing unit of the data recording device 22. In the sense of logging, diagnosis and fault finding, the temporal communication sequence may be very important in order to be able to detect and distinguish action and reaction. The time synchronization is used in this case to be able to detect the sequence of the data packets. An arrival accuracy of the data in the lower nanosecond range can be guaranteed using hardware-based time synchronization.

In addition, it should be pointed out that “comprising” does not exclude any other elements or steps and “one” does not exclude a multiplicity. Furthermore, it is pointed out that features or steps which have been described with reference to one of the above exemplary embodiments can also be used in combination with other features or steps of other exemplary embodiments described above. Reference symbols in the claims should not be considered to be a restriction.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-10. (canceled)

11. A data recording device (22) for recording communication data in a vehicle network (10), the data recording device (22) comprising:
a first input (24a) configured to receive first communication data from a first point (18, 16) in the vehicle network (10); and
a second input configured to receive second communication data from a second point (18, 16) in the vehicle network (10),
wherein the data recording device (22) is configured to provide the first communication data with a first time stamp and to provide the second communication data with a second time stamp, the first time stamp and the second time stamp being synchronized with one another.

12. The data recording device (22) as claimed in claim 11, wherein the data recording device (22) configured to temporally organize the first communication data and the second communication data using the first and second time stamps.

13. The data recording device (22) as claimed in claim 11, wherein the vehicle network (10) has Ethernet connections; the first communication data and the second communication data having Ethernet data packets.

14. The data recording device (22) as claimed in claim 11, further comprising:
a synchronization input (34) configured to synchronize the data recording device (22) with a further data recording device, such that the first and second time stamps are synchronized with time stamps of the further data recording device.

15. The data recording device (22) as claimed in claim 11, the data recording device being implemented using hardware.

16. A diagnostic arrangement (20) for a vehicle, comprising:
a vehicle network (10) for a vehicle, the network having a plurality of electronic components (14) and a plurality of network connections (16) which connect the electronic components (14); and
a data recording device (22) as claimed in claim 11.

17. The diagnostic arrangement (20) as claimed in claim 16, wherein the first input (24a) of the data recording device (22) is connected to an output of a network switch (18).

18. The diagnostic arrangement as claimed in claim 16, wherein the first input (24a) of the data recording device (22) is connected to a network line (16) by a tap (26).

19. A method for recording communication data in a vehicle network (10), the method comprising:
receiving, in a data recording device (22), first communication data from a first point (16, 18) in the vehicle network (10);
receiving, in the data recording device (22), second communication data from a second point (16, 18) in the vehicle network (10);
providing the first communication data with a first time stamp in the data recording device (22); and
providing the second communication data with a second time stamp in the data recording device (22), the first time stamp and the second time stamp being synchronized with one another.

20. The method as claimed in claim 19, further comprising:
synchronizing the data recording device (22) with a further data recording device.
